(19) United States
(12) Patent Application Publication
(10) Pub. No.: US 2026/0142514 A1
(43) Pub. Date: May 21, 2026

(54) HOLLOW SHAFT MOTOR HAVING ROTOR CAN OF NOVEL STRUCTURE

(71) Applicants: BMC CO., LTD., Anseong-si, Gyeonggi-do (KR); HL MANDO CORPORATION, Pyeongtaek-si, Gyeonggi-do (KR)

(72) Inventors: Seung Won CHU, Gwangju (KR); Jun Hyeok JANG, Gwangju (KR)

(73) Assignees: BMC CO., LTD., Anseong-si, Gyeonggi-do (KR); HL MANDO CORPORATION, Pyeongtaek-si, Gyeonggi-do (KR)

(21) Appl. No.: 19/121,117

(22) PCT Filed: Dec. 6, 2023
(86) PCT No.: PCT/KR2023/020006

§ 371 Date: Apr. 14, 2025

(30) Foreign Application Priority Data
Dec. 8, 2022 (KR) 10-2022-0170929

(51) Int. Cl. H02K 1/278; H02K 7/00

(52) U.S. Cl. CPC H02K 1/278; H02K 7/003

(57) ABSTRACT

A hollow shaft motor includes a cylindrical-shaped motor housing 11, a housing cover assembly 12 coupled to an upper part of the motor housing 11, a stator assembly 20 located inside the motor housing 11 and located at a lower part of the housing cover assembly 12, and a rotor assembly 30 located inside the stator assembly 20 and rotating thereon, wherein the rotor assembly 30 comprises a hollow shaft 31 having a hollow shaft housing 311, a plurality of magnets 32 installed on an outer circumferential surface of the hollow shaft housing 311 with spaces S spaced at regular intervals, an upper can 33 installed on an upper part of the hollow shaft housing 311, and a lower can 34 installed on a lower part of the hollow shaft housing 311.

### TECHNICAL FIELD

The present invention relates to a hollow shaft motor. More specifically, the present invention relates to a motor for preventing burnout of a motor which may be caused when magnets come into contact with each other by coupling an upper can and a lower can of a new structure around an outer circumferential surface of the hollow shaft of a hollow shaft motor used in an integrated brake system, thereby preventing magnets from deviating from their original position.

### BACKGROUND ART

In general, depending on the structure in which magnets are installed around an outer circumferential surface of the rotor forming a motor, rotors are divided into internal permanent magnet (IPM) type rotors in which magnets are insertedly coupled inside the rotor core and surface permanent magnet (SPM) type rotors in which magnets are attached to the surface of the rotor core. In the case of SPM motors, since the magnets are attached to the surface of the rotor core, a structure having a can inserted into an upper part and a lower part of the rotor may be used in order to prevent the magnets from being dislodged. Korean Patent Laid-Open No. 10-2019-0064005 (prior art 1) and Korean Patent Laid-Open No. 10-2016-0076729 (prior art 2) disclose the configuration of an SPM motor.

The SPM type motor disclosed in prior art 1 and prior art 2 has magnets inserted and placed between the guides formed on the outer circumferential surface of the rotor core in order to install a plurality of magnets, thereby incurring additional costs for processing the rotor core for inserting magnets, which not only increases the manufacturing cost of the motor but also deteriorates the assembly productivity of the motor. In addition, since the magnet is coupled to the rotor core by bonding, when the bonding force is weakened, the magnet may be dislodged from its original position by the rotational force of the rotor when the rotor rotates.

In order to overcome such problem, prior art 1 is configured to comprise a rotor part comprising a rotor core and a plurality of magnets placed spaced apart from each other on the circumferential surface of the rotor core, a first can covering an upper part of the rotor part, and a second can covering a lower part of the rotor part, the first can comprising a first protrusion located in spaces formed between the magnets, and the second can comprising a second protrusion located in spaces formed between the magnets, such that the first protrusion and the second protrusion are placed alternately along a circumferential direction of the rotor core, the first can comprises a first groove formed as a region of an outer circumferential surface of the first protrusion is pressed, and a lower side of the first groove communicates with spaces located at an inner side of the second protrusion.

As such, prior art 1 has the first can and the second can to come into contact with each other so that the first protrusion and the second protrusion are alternately placed at different positions between the magnets. Thus, the second protrusion of the second can should be accurately located at a lower side between the first protrusions of the first can. However, during the process of coupling the first can and the second can, since it is difficult to accurately place the first protrusion and the second protrusion in the right position, there may be an error in the assembly process. Also, since the first protrusion and the second protrusion must be accurately fitted in the center space between the magnets at different positions, an error may occur when the assembly accuracy of the first can and the second can is low, which makes the assembly process of the cans complex.

In addition, prior art 1 is a structure in which a magnet long in the vertical direction is fixed in a mutually inconsistent position by protrusions in the center of the two cans, and at the same time, a structure in which the protrusions are located in the central part of the long magnet in the center of the two cans, which make it difficult to fix the upper part and the lower part of the magnet in a solid state. Thus, since the magnet is supported by protrusions at both ends of the central part of the magnet, an upper part or a lower part of the magnet may deviate from its original position due to the strong rotational force when the rotor core rotates, and the upper part or the lower part of the magnet may come into contact with other magnets, causing the current flowing in the coil of the stator to be in an overcurrent state and causing the motor to burn out. In addition, the first protrusion and the second protrusion may be deformed by the dislodging of the magnet, making it difficult for the magnets to maintain a solid and stable state, thereby deteriorating the performance and quality of the motor.

In addition, prior art 1 is configured to place the first protrusion and the second protrusion alternately, and thus may be applied when the plurality of magnets is an even number. However, when the number of magnets is an odd number, it is difficult to apply the first can and the second can to the same part.

In prior art 2, two cans are installed around the outer circumference of magnets located on the outer circumference of the rotor core at intervals, and then bending parts are formed inwardly by caulking at intervals around the circumference of each of the first can and the second can, so that the magnets are placed at intervals by being fitted into the magnet-to-magnet slits. However, according to prior art 2, it is very difficult to accurately fit the bending part into the slit between the magnets at the inner side during the caulking operation, and the magnet may be damaged by the caulking operation of strong pressure, resulting in deterioration in motor quality and productivity.

Meanwhile, in general, brake systems generate pressure from a master cylinder to amplify the force acting on the brakes, thereby providing pressure to modules that require braking. As such, hollow shaft motors are used as a device for generating pressure in the master cylinder. Such hollow shaft motors use the principle of rotating a hollow shaft by the principle of a motor, and applying a screw to the inside of the hollow shaft to convert the rotational motion of the screw into a linear motion. The linear motion of the screw operates the piston to generate or remove the pressure required in the master cylinder.

Recently, motors with such hollow shafts are mainly used in electronic brake systems, and the present inventors aims at suggesting a hollow shaft motor of a new structure which takes advantage of the advantages of SPM motors while solving the above problems of prior art.

### SUMMARY OF INVENTION

### Technical Task

It is an object of the present invention to provide a hollow shaft motor capable of preventing burnout of the motor by preventing dislodged magnets from coming into mutual contact with an adjacent magnet even when the magnets installed on the hollow shaft are dislodged from the surface of the hollow shaft due to causes such as weakening of adhesion.

It is another object of the present invention to provide a hollow shaft motor of a new structure capable of preventing dislodging of magnets without an additional processing for coupling the rotor core to the hollow shaft.

It is yet another object of the present invention to provide a hollow shaft motor fixing a magnet stably and balancedly by accurately placing the magnet in the right position by stably fixing both ends of center of the upper part and the lower part of each magnet by the first protrusion and the second protrusion formed on the upper can and the lower can.

It is still yet another object of the present invention to provide a hollow shaft motor applicable to an upper can and a lower can having the same structure, capable of improving assembly and productivity by placing the protrusions of each of the upper can and the lower can on the same line in the vertical direction, and enabling universal use of a plurality of magnets not only for motors installed in even numbers but also odd numbers.

It is still yet another object of the present invention to provide a hollow shaft motor capable of improving assembly and preventing deterioration of motor quality due to magnet damage by installing the upper can and the lower can around the magnet without damaging the magnet.

The above object and other objects of the present invention may be easily achieved by the present invention described below.

### Means for Solving Technical Task

A hollow shaft motor according to the present invention comprises:
a cylindrical-shaped motor housing 11;
a housing cover assembly 12 coupled to an upper part of the motor housing 11;
a stator assembly 20 located inside the motor housing 11 and located at a lower part of the housing cover assembly 12; and
a rotor assembly 30 located inside the stator assembly 20 and rotating thereon;
wherein the rotor assembly 30 comprises:
a hollow shaft 31 having a hollow shaft housing 311;
a plurality of magnets 32 installed on an outer circumferential surface of the hollow shaft housing 311 with spaces S spaced at regular intervals;
an upper can 33 installed on an upper part of the hollow shaft housing 311 so as to surround an upper part of the magnet 32; and
a lower can 34 installed on a lower part of the hollow shaft housing 311 so as to surround a lower part of the magnet 32;
wherein a plurality of first protrusions 330 and a plurality of second protrusions 340 protruding at intervals inwardly to the center of each of the upper can 33 and the lower can 34 are formed at regular intervals, and the first protrusions 330 and the second protrusions 340 are located in the spaces S.

In the present invention, the upper can 33 comprises a cylindrical-shaped upper can body 331 having an upper part and a lower part open; and an upper annulus 332 formed by protruding inwardly to an upper part of the upper can body 331, and the plurality of first protrusions 330 are formed by protruding at regular intervals inwardly to the center of the upper can body 331.

In the present invention, the first protrusion 330 comprises a first central protruding surface 330A; and a first upper inclined surface 330B and a first lower inclined surface 330C each formed extending from an upper part and a lower part of the first central protruding surface 330A, and the first central protruding surface 330A is located in the spaces S allowing the upper part of the plurality of magnets 32 to be installed with spaces S maintained by the plurality of first protrusions 330.

In the present invention, a long hole H communicating with the first central protruding surface 330A, the first upper inclined surface 330B and the first lower inclined surface 330C is formed in the first protrusion 330.

In the present invention, an inner side surface of the first central protruding surface 330A is in surface contact with an outer circumferential surface of the hollow shaft housing 311.

In the present invention, the lower can 34 comprises a cylindrical-shaped lower can body 341 having an upper part and a lower part open; and a lower annulus 342 formed by protruding inwardly to a lower part of the lower can body 341, and wherein the second protrusion 340 is formed by protruding at regular intervals inwardly to the center of the lower can 340.

In the present invention, the second protrusion 340 comprises a second central protruding surface 340A; and a second upper inclined surface 340B and a second lower inclined surface 340C each formed extending from an upper part and a lower part of the second central protruding surface 340A, and the second central protruding surface 340A is located in the spaces S between the magnets 32 allowing the lower part of the plurality of magnets 32 to be installed with spaces S maintained by the plurality of second protrusions 340.

In the present invention, a long hole H communicating with the second central protruding surface 340A, the second upper inclined surface 340B and the second lower inclined surface 340C is formed in the second protrusion 340.

In the present invention, an inner side surface of the second central protruding surface 340A is in surface contact with an outer circumferential surface of the hollow shaft housing 311.

In the present invention, the upper can 33 and the lower can 34 stay out of contact with each other, and the first protrusion 330 and the second protrusion 340 are each located on the same line in a vertical direction in the same space S.

In the present invention, the first protrusion 330 and the second protrusion 340 are located in the same space S in pairs, and the first protrusion 330 and the second protrusion 340 are located in every space S.

### Effect of invention

The present invention has an effect of greatly improving the quality and reliability of a motor by preventing, when a magnet bonded to an outer circumferential surface of a hollow shaft housing is dislodged from the hollow shaft housing due to a weakening of adhesion, the dislodged magnet from being dislodged outwardly by the first protrusion and the second protrusion formed on the inner side of each of the upper can and the lower can, and at the same time, preventing burnout of the motor caused when magnets come into contact with each other by not allowing the dislodged magnet to come into contact with an adjacent magnet.

The present invention has an effect of lowering manufacturing costs and increasing assembly and productivity by providing an upper and lower can of a new structure in which a magnet is installed directly on a hollow shaft produced by press processing without a rotor core, which prevents the magnet from being dislodged without a separate hollow shaft processing to insert the magnet.

The present invention has an effect of broadening the scope of application by enabling a can having a single same structure to be used as an upper can and a lower can, which allows the first protrusion and the second protrusion formed on each of the upper can and the lower can to be placed on the same line in the vertical direction, and enables universal use of a plurality of magnets not only for motors installed in even numbers but also add numbers.

The present invention has an effect of enabling the magnets to be fixed stably and balancedly by accurately placing the magnet in the right position by stably fixing both ends of the center of the upper part and the lower part of each magnet.

The present invention has an effect of improving the quality of the motor by enabling the assembly of cans without damaging the magnet by the elastic force applied to the protrusions of each of the upper can and the lower can, and at the same time reducing deformation of the protrusions of each of the upper can and the lower can so as to maintain stable installation of the magnets.

### BRIEF DESCRIPTION OF DRAWINGS

FIG. 1 is a perspective view of a hollow shaft motor according to the present invention;

FIG. 2 is an exploded perspective view of a hollow shaft motor according to the present invention;

FIG. 3 is an exploded perspective view of a rotor assembly of the hollow shaft motor according to the present invention;

FIG. 4 is a cross-sectional view of a rotor assembly of the hollow shaft motor according to the present invention;

FIG. 5 is a cross-sectional view taken along line A-A of FIG. 4;

FIG. 6 is a cross-sectional view taken along line B-B of FIG. 5; and

FIG. 7 is a cross-sectional view of a hollow shaft motor according to the present invention.

The present invention will be described in detail below with reference to the attached drawings.

### BEST MODE FOR CARRYING OUT THE INVENTION

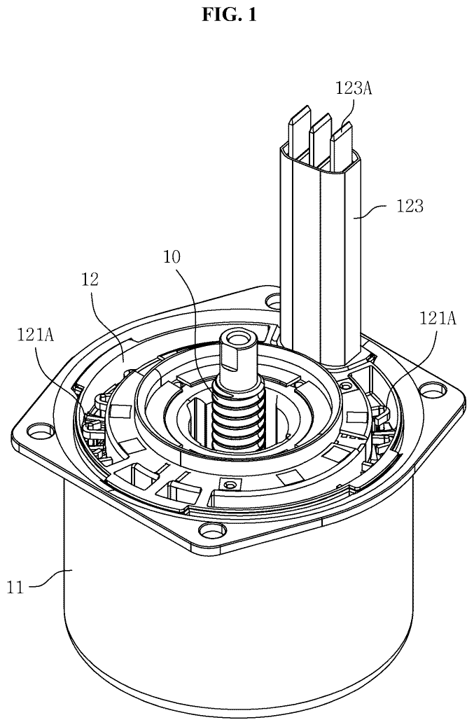

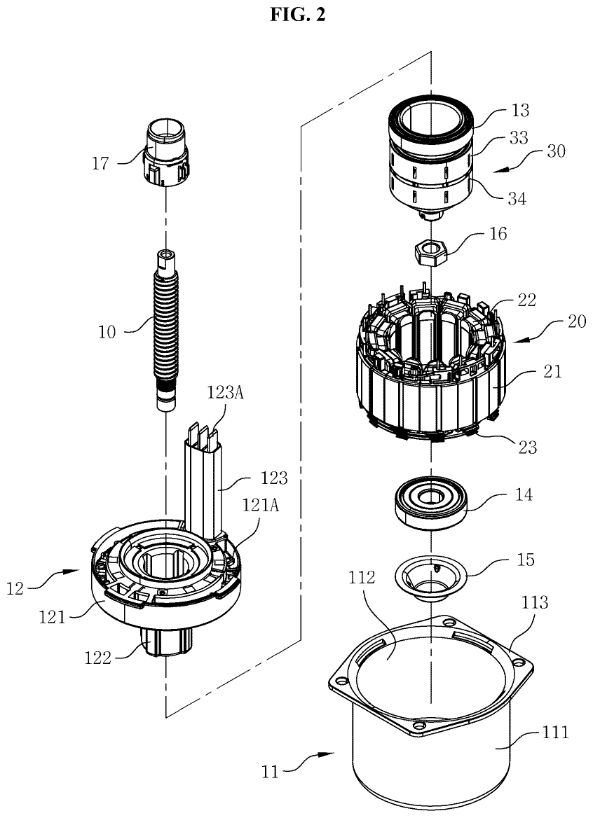

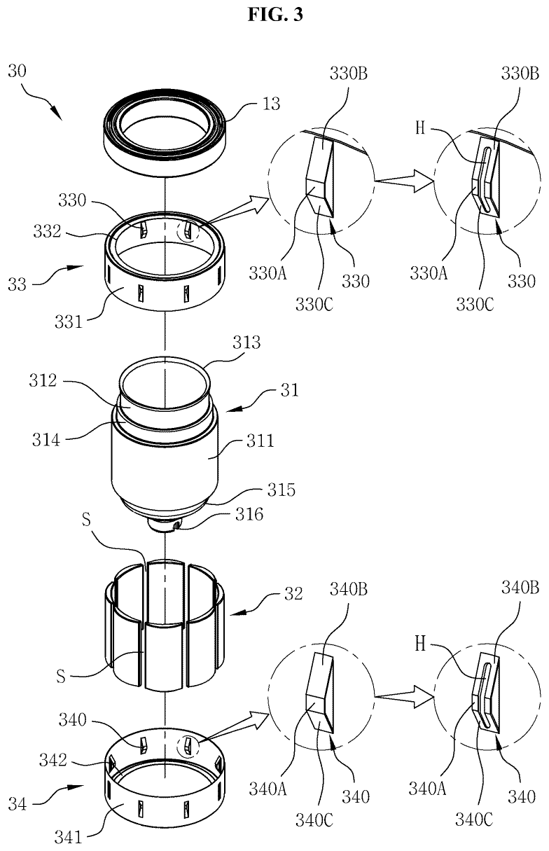

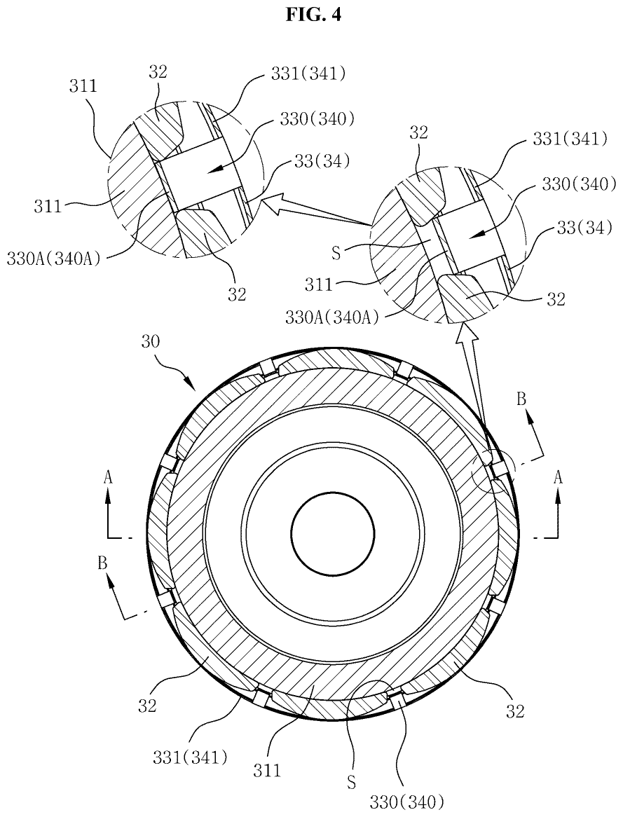

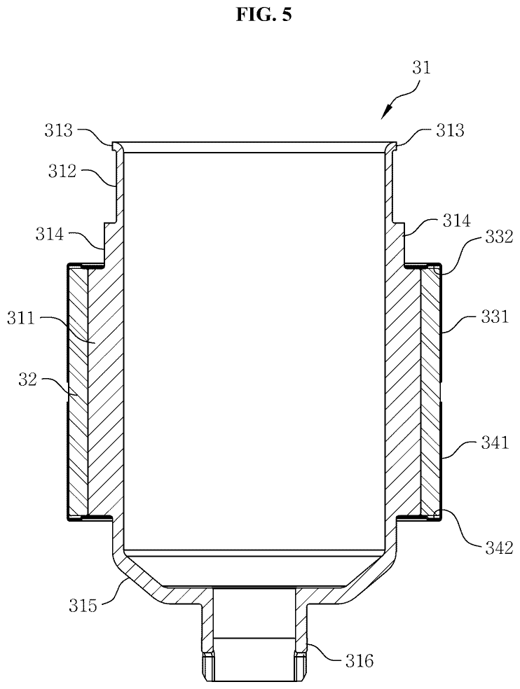

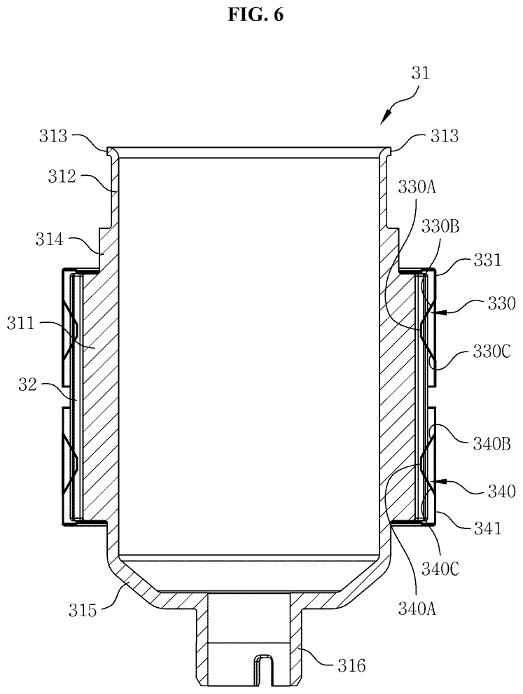

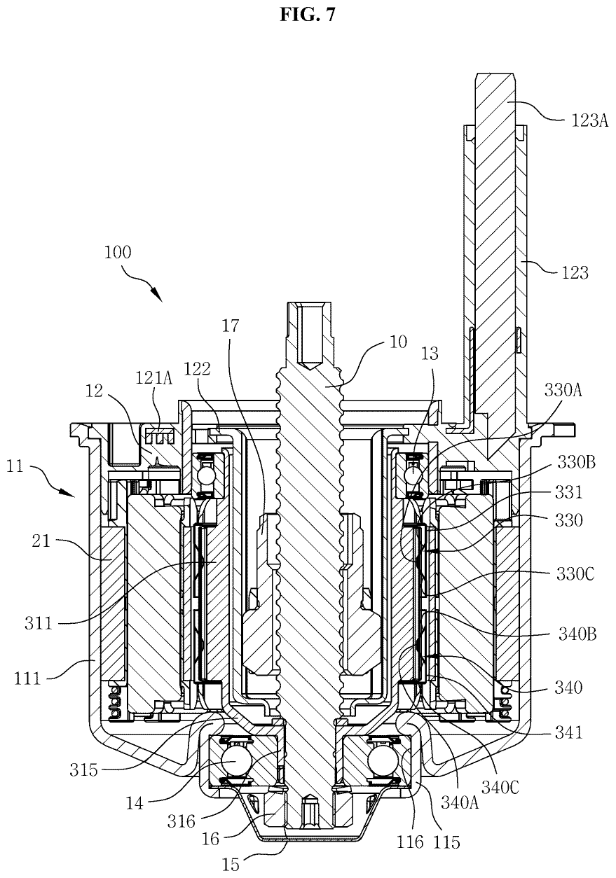

FIG. 1 is a perspective view of a hollow shaft motor 100 according to the present invention. FIG. 2 is an exploded perspective view of a hollow shaft motor 100 according to the present invention. FIG. 3 is an exploded perspective view of a rotor assembly 30 of the hollow shaft motor 100 according to the present invention. FIG. 4 is a cross-sectional view of a rotor assembly 30 of the hollow shaft motor 100 according to the present invention. FIG. 5 is a cross-sectional view taken along line A-A of FIG. 4. FIG. 6 is a cross-sectional view taken along line B-B of FIG. 5. FIG. 7 is a cross-sectional view of a hollow shaft motor 100 according to the present invention.

As illustrated in FIGS. 1 to 7, the hollow shaft motor 100 according to the present invention comprises a screw shaft 10, a motor housing, 11, a stator assembly 20 coupled to an inner side of the motor housing 11, and a rotor assembly 13 located at an inner side of the stator assembly 20.

The screw shaft 10 has a lower end part coupled to a hollow shaft 31 to rotate with the rotor assembly 30. Coupled to an outer circumferential surface of the screw shaft 10 is a ball nut 17, which is moved to an upper part or a lower part according to the rotation of the screw shaft 10 to generate or remove pressure in the piston (not shown).

The motor housing 11 may be manufactured through a continuous process by press processing equipment such as a transfer mold. The motor housing 11 has a cylindrical-shaped body part 111 having an upper part and a lower part open. The part open toward an upper part of the motor housing 11 is an inner space part 112, and a flange part 113 extending in a horizontal direction is formed around an upper part of the inner space part. In the inner space part 112, a housing cover assembly 12 is coupled to cover an upper part of the inner space part 112. The flange part 113 is coupled to a block (not shown) of the brake system.

The housing cover assembly 12 comprises a housing cover 121 made from a plastic mold. The housing cover 121 has a sleeve 122 formed to protrude from a lower part thereof.

An inner ring of the upper bearing 13 is coupled to an upper bearing coupling groove 312 formed on an upper part of the hollow shaft 31 to support the rotation of the hollow shaft 31. The sleeve 122 extends downwardly from a space inside the hollow shaft 31, thereby independently separating the hollow shaft 31 from the space inside the sleeve 122.

A lower bearing 14 supports the rotation of a lower bearing support part 316 formed on a lower end part of the hollow shaft 31. The lower bearing 14 is coupled to a lower bearing support part 116 formed at a lower end of the motor housing 11.

As illustrated in FIG. 7, a rear cover 15 is coupled to an inner side of a lower end of the lower protrusion 115 of the motor housing 11 to cover a lower part of the lower protrusion 115. The rear cover 15 is coupled to an inner side at a lower end of the lower protrusion 115 to be fixed. A lock nut 16 is coupled to a lower end of the screw shaft 10.

The stator assembly 20 comprises a stator core 21 press-fitted to an inner side of a body part 111 of the motor housing 11, an upper insulator 22 coupled to an upper part of the stator core 21, and a lower insulator 23 coupled to a lower part thereof.

Coils (not shown) are wound around the upper insulator 22 and the lower insulator 23, and the coils are electrically connected to a busbar 121A of the housing cover assembly 12 coupled to be located at an upper part of the upper insulator 22. The busbar 121A is electrically connected to a busbar terminal 123A to which external power may be applied. The busbar terminal 123A is enclosed and protected by a terminal cover 123.

The rotor assembly 30 of the present invention is located at an inner side of the stator assembly 20 to rotate. To this end, the rotor assembly 30 comprises a hollow shaft 31 formed by press processing, a plurality of magnets 32 installed to be spaced at regular intervals along an outer circumferential surface of the hollow shaft housing 311 of the hollow shaft 31, and an upper can 33 and a lower can 34 installed on an upper part and a lower part of the hollow shaft housing 311, respectively.

An upper bearing coupling groove 312 having a diameter slightly smaller than the diameter of the hollow shaft housing 311 is formed on an upper part of the hollow shaft housing 311. An inner ring of the upper bearing 13 has its rotation supported by the upper bearing coupling groove 312. An upper step part 313 having an outwardly bent shape is formed on an upper part of the upper bearing coupling groove 312, and a lower step part 314 is formed on a lower part of the upper bearing coupling groove 312, so as to have a groove shape for coupling the inner ring of the upper bearing 13 to the upper bearing coupling groove 312.

A shaft diameter part 315, a part bent and connected so that the diameter of a lower end part of the hollow shaft housing 311 is gradually reduced to the diameter of the lower bearing support 316, is formed on a lower end part of the hollow shaft housing 311. The lower bearing support part 316 protruding from the shaft diameter part 315 has its rotation supported by the lower bearing 14.

Preferably, the upper can 33 and the lower can 34 are made of stainless steel, and the upper can 33 and the lower can 34 are of the same structure to be installed at regular intervals in a perpendicular direction so as to be symmetrical to each other, thereby preventing the magnets 32 from being dislodged.

The upper can 33 comprises a cylindrical-shaped upper can body 331 having an upper part and a lower part open, an upper annulus 332 formed by protruding inwardly to an upper part of the upper can body 331, and a plurality of first protrusions 330 formed by protruding at regular intervals inwardly to the center of the upper can body 331. The first protrusion 330 is molded to protrude by press processing, such as punching, inwardly to the center of the upper can body 331.

The first protrusion 330 comprises a first central protruding surface 330A of an inner side of the center, and a first upper inclined surface 330B and a first lower inclined surface 330C each extending from an upper part and a lower part of the first central protruding surface 330A. This structure facilitates assembly and minimizes damage to the magnet when coupling the upper can 33 to the hollow shaft 31. The first central protruding surface 330A, the first upper inclined surface 330B and the first lower inclined surface 330C may form a single curved surface connected to each other.

The first protrusion 330 is located at spaces S between the magnets 32, allowing the upper part of the plurality of magnets 32 to be installed with spaces S maintained by the plurality of first protrusions 330.

In another embodiment of the first protrusion 330, as illustrated in FIG. 3, a long hole H communicating with the first central protruding surface 330A, the first upper inclined surface 330B and the first lower inclined surface 330C is formed so that the first protrusion 330 located at spaces S between the magnets 32 has an elastic force by the long hole H. Thus, when assembling the upper can 33, the first protrusion 330 may be press-fitted into spaces S between two adjacent magnets without damaging the magnets 32 so as to support the magnets 32 at both ends.

In another embodiment of the first protrusion 330, as illustrated in FIG. 4, a first central protruding surface 330A may extend inwardly so that the inner side surface of the first central protruding surface 330A comes into surface contact with the outer circumferential surface of the hollow shaft housing 311. Thus, the first central protruding surface 330A and the outer circumferential surface of the hollow shaft housing 311 may be bonded with an adhesive to improve the adhesion of the upper can 33, thereby more effectively preventing the magnet 32 from dislodging from its original position.

The lower can 34 comprises a cylindrical-shaped lower can body 341 having an upper part and a lower part open, and a lower annulus 342 formed by protruding inwardly to a lower part of the lower can body 341. A plurality of second protrusions 340 are formed by protruding at regular intervals inwardly to the center of the lower can body 341. The second protrusion 340 is molded to protrude by press processing, such as punching, inwardly to the center of the lower can body 341.

The second protrusion 340 comprises a second central protruding surface 340A of an inner side of the center, and a second upper inclined surface 340B and a second lower inclined surface 340C each extending from an upper part and a lower part of the second central protruding surface 340A. This structure facilitates assembly and minimizes damage to the magnet when coupling the lower can 34 to the hollow shaft 31. The second central protruding surface 340A, the second upper inclined surface 340B and the first lower inclined surface 330C may form a single curved surface connected to each other.

The second protrusion 340 is located at spaces S between the magnets 32, allowing the lower part of the plurality of magnets 32 to be installed with spaces S maintained by the plurality of second protrusions 340.

A second upper inclined surface 340B and a second lower inclined surface 340C may be formed on each of the upper part and the lower part of the second central protruding surface 340A to provide easy assembly when coupling the lower can 34 to the hollow shaft 31.

In another embodiment of the second protrusion 340, as illustrated in FIG. 3, a long hole H communicating with the second central protruding surface 340A, the second upper inclined surface 340B and the second lower inclined surface 340C is formed so that the second protrusion 340 located at spaces S between the magnets 32 has an elastic force by the long hole H. Thus, when assembling the lower can 34, the second protrusion 340 may be press-fitted into spaces S between two adjacent magnets without damaging the magnets 32 so as to support the magnets 32 at both ends.

In another embodiment of the second protrusion 340, as illustrated in FIG. 4, a second central protruding surface 340A may be extended inwardly so that the inner side surface of the second central protruding surface 340A comes into surface contact with the outer circumferential surface of the hollow shaft housing 311. Thus, the second central protruding surface 340A and the outer circumferential surface of the hollow shaft housing 311 may be bonded with an adhesive to improve the adhesion of the lower can 34, thereby more effectively preventing the magnet 32 from dislodging from its original position.

The upper can 33 and the lower can 34 have the same structure and are installed symmetrically on an upper part and a lower part of the hollow shaft housing 311. The upper can 33 and the lower can 34 may be kept out of contact with each other to eliminate errors in assembly. At this time, alignment marking grooves (not shown) may be formed on a lower outer surface of the upper can 33 and an upper outer surface of the lower can 34 to facilitate assembly so that the first protrusion 330 and the second protrusion 340 are located at the same spaces S and at the same time located in a straight line in the vertical direction.

A lower part of the upper can 33 and an upper part of the lower can 34 stay spaced apart from each other so that the first protrusion 330 and the second protrusion 340 of each of the upper can 33 and the lower can 34 are symmetrically located on the same line in the vertical direction. Accordingly, magnets 32 may be fixed stably and balancedly so that the magnets 32 are accurately placed in the right position by stably fixing both ends of the center of the upper part and both ends of the center of the lower part of the magnet 32 that is long in the vertical direction. In addition, the present invention has an advantage that the plurality of magnets 34 may be applicable to both motors having an odd number of magnets or an even number of magnets. At this time, a pair of first protrusion 330 and second protrusion 340 are located in the same space S, with a first protrusion 330 and a second protrusion 340 located in every space S.

A preferable exemplary assembly process of the magnet 32, upper can 33 and lower can 34 according to the present invention with such a structure will be described.

Magnets 32 are located to fit in between the first protrusion 330 and the second protrusion 340 of each of the upper can 33 and the lower can 34. At this time, the outer surface of each of the magnet 32 is bonded to an inner surface of each of the upper can 33 and the lower can 34 with an adhesive, and then the upper can 33 and the lower can 34 are press-fitted on an outer circumferential surface of the hollow shaft housing 311 while having an adhesive applied to the inner surface of each magnet 32, so that the upper can 33 and the lower can 34 are installed without damaging the magnet 32 with a strong adhesive force through the process of attaching the inner surface of the magnet 32 to the outer circumferential surface of the hollow shaft housing 311 with the adhesive.

As such, the present invention prevents the upper part and the lower part of the magnets 32 from being damaged even when a strong rotational force of the hollow shaft 310 is generated when the hollow shaft motor 100 is driven, and at the same time prevents the magnets 32 from being dislodged, by maintaining its right position in the center of the upper part and the center of the lower part of the magnet 32 by the first protrusion 330 and the second protrusion 340, while preventing outward scattering of the magnet 32 by the adhesive force by the adhesive between the outer surface of the magnet and the inner surfaces of each of the upper can 33 and the lower can 34 even when the magnets 32 located along the outer circumferential surface of the hollow shaft housing 311 is dislodged, thereby preventing burnout of the motor caused by overheating of the stator core 21 when the magnets come into contact with each other.

It should be noted that the description of the present invention described above is merely an example for understanding the present invention, and is not intended to limit the scope of the present invention. It should be construed that the scope of the present invention is defined by the appended claims, and all modifications and alternations of the present invention fall within the protection scope of the present invention.

1. A hollow shaft motor, comprising:
a cylindrical-shaped motor housing 11;
a housing cover assembly 12 coupled to an upper part of the motor housing 11;
a stator assembly 20 located inside the motor housing 11 and located at a lower part of the housing cover assembly 12; and
a rotor assembly 30 located inside the stator assembly 20 and rotating thereon;
wherein the rotor assembly 30 comprises:
a hollow shaft 31 having a hollow shaft housing 311;
a plurality of magnets 32 installed on an outer circumferential surface of the hollow shaft housing 311 with spaces S spaced at regular intervals;
an upper can 33 installed on an upper part of the hollow shaft housing 311 so as to surround an upper part of the magnet 32; and
a lower can 34 installed on a lower part of the hollow shaft housing 311 so as to surround a lower part of the magnet 32;
wherein a plurality of first protrusions 330 and a plurality of second protrusions 340 protruding at intervals inwardly to the center of each of the upper can 33 and the lower can 34 are formed at regular intervals, and the first protrusions 330 and the second protrusions 340 are located in the spaces S.

2. The hollow shaft motor of claim 1, wherein the upper can 33 comprises a cylindrical-shaped upper can body 331 having an upper part and a lower part open; and an upper annulus 332 formed by protruding inwardly to an upper part of the upper can body 331, and the plurality of first protrusions 330 are formed by protruding at regular intervals inwardly to the center of the upper can body 331.

3. The hollow shaft motor of claim 1, wherein the first protrusion 330 comprises a first central protruding surface 330A; and a first upper inclined surface 330B and a first lower inclined surface 330C each formed extending from an upper part and a lower part of the first central protruding surface 330A, and the first central protruding surface 330A is located in the spaces S allowing the upper part of the plurality of magnets 32 to be installed with spaces S maintained by the plurality of first protrusions 330.

4. The hollow shaft motor of claim 3, wherein a long hole H communicating with the first central protruding surface 330A, the first upper inclined surface 330B and the first lower inclined surface 330C is formed in the first protrusion 330.

5. The hollow shaft motor of claim 3, wherein an inner side surface of the first central protruding surface 330A is in surface contact with an outer circumferential surface of the hollow shaft housing 311.

6. The hollow shaft motor of claim 1, wherein the lower can 34 comprises a cylindrical-shaped lower can body 341 having an upper part and a lower part open; and a lower annulus 342 formed by protruding inwardly to a lower part of the lower can body 341, and wherein the second protrusion 340 is formed by protruding at regular intervals inwardly to the center of the lower can 34.

7. The hollow shaft motor of claim 1, wherein the second protrusion 340 comprises a second central protruding surface 340A; and a second upper inclined surface 340B and a second lower inclined surface 340C each formed extending from an upper part and a lower part of the second central protruding surface 340A, and the second central protruding surface 340A is located in the spaces S between the magnets 32 allowing the lower part of the plurality of magnets 32 to be installed with spaces S maintained by the plurality of second protrusions 340.

8. The hollow shaft motor of claim 7, wherein a long hole H communicating with the second central protruding surface 340A, the second upper inclined surface 340B and the second lower inclined surface 340C is formed in the second protrusion 340.

9. The hollow shaft motor of claim 7, wherein an inner side surface of the second central protruding surface 340A is in surface contact with an outer circumferential surface of the hollow shaft housing 311.

10. The hollow shaft motor of claim 1, wherein the upper can 33 and the lower can 34 stay out of contact with each other, and the first protrusion 330 and the second protrusion 340 are each located on the same line in a vertical direction in the same space S.

11. The hollow shaft motor of claim 10, wherein the first protrusion 330 and the second protrusion 340 are located in the same space S in pairs, and the first protrusion 330 and the second protrusion 340 are located in every space S.
